(19) United States
(12) Patent Application Publication
(10) Pub. No.: US 2007/0058822 A1
(43) Pub. Date: Mar. 15, 2007

(54) Noise reducing apparatus, method and program and sound pickup apparatus for electronic equipment

(75) Inventor: Kazuhiko Ozawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/518,895

(22) Filed: Sep. 12, 2006

(30) Foreign Application Priority Data
Sep. 12, 2005 (JP) 2005-264157

(51) Int. Cl. H04B 15/00

(52) U.S. Cl. 381/94.1

(57) ABSTRACT

A noise reducing apparatus is disclosed, which includes: input means for inputting multiple audio signals from multiple audio channels; multiple band extracting means for extracting a predetermined band from the multiple audio signals; calculating means for averaging signals from the multiple band extracting means; multiple first level detecting means for detecting the signal levels in a predetermined period of time of the signals from the multiple band extracting means; second level detecting means for detecting the signal level in a predetermined period of time of the signal from the calculating means; selecting means for selecting, for each of the predetermined period of times, the signal having the lowest level value of the level values detected by the multiple first level detecting means and the second level detecting means; band limiting means for limiting the band of the signal from the selecting means; and band synthesizing means for band-synthesizing the signal from the band limiting means and the signal in a band, which is not extracted by the multiple band extracting means, for each audio channel, wherein the output of the band synthesizing means is an audio channel output signal.

### CROSS REFERENCES TO RELATED APPLICATIONS

The present invention contains subject matter related to Japanese Patent Application JP2005-264157 filed in the Japanese Patent Office on Sep. 12, 2005 the entire contents of which being incorporated herein by reference.

### BACKGROUND OF THE INVENTION

1. Field of the Invention

The present invention relates to a noise reducing apparatus, method and program and sound pickup apparatus for electronic equipment, which allow the reduction of noise in an electric circuit due to the wind through a microphone and, in particular, a noise reducing apparatus, method and program and sound pickup apparatus for electronic equipment, which minimize, select and re-synthesize multiple microphone signals for each predetermined period of time.

2. Description of the Related Art

In order to prevent wind noise in the outdoor picking-up with a large broadcasting or industrial video camera in the past, a wind preventing device called wind jammer may be attached to a microphone or a microphone may be covered by urethane. Instead of the mechanical wind preventing device, an internal microphone of an audio recording apparatus for mobile electronic equipment such as a home video camera may often have wind-preventing measures in an electric circuit construction for a smaller size. The wind preventing measures in such an electric circuit construction in the past may include:

1. Controlling and converting the directivity (such as a sound-field characteristic and separation) of each sound signal to a monaural form;

2. Attenuating the level of the frequency band including a large amount of a wind noise component; and

3. Changing sound-field creating/calculating processing and canceling the directivity.

These measures may be often performed independently or in combination.

For example, Patent Document 1 discloses a sound pickup apparatus having measures of both 1 and 2 above on a first low frequency component including a wind component and automatically controlling the characteristic by using a signal from which a second low frequency component including a larger amount of a wind noise component is detected. FIG. 13 shows an entire block diagram of an automatic wind noise reducing circuit having two left/right (called L/R hereinafter) channels of a picking-up apparatus disclosed in Patent Document 1. The parts enclosed by the broken lines in FIG. 13 show schematic block diagrams of the control sections. In FIG. 13, a right audio signal (called Rch hereinafter) and left audio signal (called Lch hereinafter) input from an R-microphone 1 and an L-microphone 2 include analog audio signals and wind noise signals, which are digitally converted by an analog-digital converters (called ADCs hereinafter) 5 and 6 through amplifiers (called AMPs hereinafter) 3 and 4. Then, the Rch side is input, as digital data, to a delay unit (called DL hereinafter) 7 and the minus terminal of an adder 9. The Lch side is input, as digital data, to a DL 8 and the plus terminal of the adder 9. The adder 9 calculates the difference signal component (L-R) of both, which is then input to low-pass filters (called LPFs hereinafter) 10 and 21.

FIG. 14 shows a frequency characteristic example of a wind noise signal in a general video camera. The level of the wind noise signal increases with the 1/F characteristic (where F is a frequency) toward the lower frequency side with respect to about 1 kHz. However, because of the characteristic of a used microphone and/or the coupling capacitor connecting to the analog circuit in the input stage, the level decreases at an extremely low frequency and therefore has the peak around 100 to 200 Hz. Furthermore, due to the swirling airflow (which may be called Kalman swirl) occurring in the vicinity of a microphone, the wind noise signals from multiple microphones approximate to random signals having less correlation than audio signals. Since wind noise signals have no correlation between L and R channels, a large amount of wind noise component is extracted from the difference signal component (L-R). The LPF 21 only extracts wind noise signals, which hardly include audio signals from an extremely low frequency component therethrough (in a wind noise extracting section 33 in the part enclosed by the broken line in FIG. 13). The output of the LPF 21 is amplified by the AMP 22, and the level of the wind noise signals is detected by a detector (called DET hereinafter) 23 (in a detecting section 34 in the part enclosed by the broken line in FIG. 13). A MAKECOEF (control coefficient creating unit) 24 creates a control coefficient to be supplied to the next stage, and the wind noise level detection signal along with an attack/recovery time constant is obtained (in a control value creating section 35 in the part enclosed by the broken line in FIG. 13).

The LPF 10 can extract most wind noise signals by allowing a low frequency wind noise band shown in FIG. 14 to pass through, and a level adjusting unit 11 controls the level of the signals by using a wind noise level detection signal. In this case, the level adjusting unit 11 controls to provide a large output for a large amount of wind noise, that is, when the level of the wind noise level detection signal is high. On the other hand, with no wind noise, the level adjusting unit 11 controls the level of the wind noise level detection signal to zero and outputs zero. Then, the adder 12 adds the output of the level adjusting unit 11 and the signal having passed through the DL 7, and the adder 13 subtracts the output of the level adjusting unit 11 from the signal having passed through the DL 8 (in a first control section 31 in the part enclosed by the broken lines in FIG. 13).

The meaning of the calculation may be expressed as below:
Ra=(Rs+Rw)+0.5(Lw−Rw)=Rs+0.5(Lw+Rw) [EQ1]
La=(Ls+Lw)−0.5(Lw−Rw)=Ls+0.5(Lw+Rw) [EQ2]
where Ra is the output of the adder 12, La is the output of the adder 13, Ls is an audio signal of the Lch, Lw is a wind noise signal thereof, Rs is an audio signal of the Rch, Rw is a wind noise signal thereof, and the output/input ratio of the level adjusting unit 11 is defined as 0.5 times with maximum wind noise.

In other words, both of large wind noise signals Rw and Lw results in the (Lw+Rw) component, which is a monaural signal. When the wind noise signals Rw and Lw are zero, the respective audio signals Rs and Ls are output. Because of less inter-channel correlation than audio signals, wind noise signals can be added to be largely reduced. The synchronization of the signal timings in the adders 12 and 13 further increases the reduction effect since the DLs 7 and 8 compensate the delay by the LPF 10 on the main line side. The outputs of the adder 12 and 13 are input to the DLs 15 and 16, respectively, and are input to and added in the adder 14. The output is input to the LPF 17. The LPF 17 has a band setting to extract a wind noise band like the LPF 10.

The output of the LPF 17 is level-controlled by the wind noise level detection signal in the level adjusting unit 18. The output is controlled to be large with a large amount of wind noise, that is, when the level of the wind noise level detection signal is high while the output is controlled to zero when the level of the wind noise level detection signal is zero with no wind noise. The adder 19 subtracts the output of the level adjusting unit 18 from the signal having passed through the DL 15. The adder 20 subtracts the output of the level adjusting unit 18 from the signal having passed through the DL 16 (in a second control unit 32 in FIG. 13).

The meaning of the calculation may be expressed as below:
Rb=Rs+0.5(Lw+Rw)−0.5(Lw+Rw)=Rs [EQ3]
Lb=Ls+0.5(Lw+Rw)−0.5(Lw+Rw)=Ls [EQ4]
where Rb is the output of the adder 19, Lb is the output of the adder 20, and the output/input ratio of the level adjusting unit 18 is defined as 0.5 times with maximum wind noise based on EQ1 and EQ2.

Therefore, the wind noise signals Rw and Lw are cancelled, and only audio signals Rs and Ls can be obtained. Since the DLs 15 and 16 compensate the delay by the LPF 17 on the main line side, the synchronization of the signal timings in the adders 19 and 20 further increases the reduction effect. Therefore, the adders 19 and 20 output audio signals having reduced wind noise signals, which are then input to recording signal processing, if in a video camera, and are recorded on a recording medium such as a tape along with separately prepared video signals.

In a microphone apparatus, reproduced audio signal processing apparatus and wind noise reducing apparatus for audio signal disclosed in Patent Document 2, a minimum clip level and a maximum limiter level are provided for a detection signal from a detecting section of the sound pickup apparatus disclosed in Patent Document 1. Patent Document 2 discloses a microphone, which can securely reduce wind noise signals only from audio signals from L/Rch even when the amount of unrelated components of the left and right channel audio signals increases. The unrelated components may result from an imbalance in characteristics of L/Rch circuits in the previous circuit of the wind noise reducing circuit that reduces wind noise included in audio signals of the L/Rch based on multiple audio signals from multiple microphones, forms of microphones used for picking-up, forms and attaching method of surrounding wind preventing devices (such as a sponge and wire netting), differences in spaces between microphones, and conversion of audio signals from multiple microphones used for picking-up to L/Rch audio signals by a stereo conversion processing circuit.

Patent Document 3 discloses a wind noise reducing method and apparatus therefor that detect the synchronism of 1/f fluctuation of a wind component in a sound picked-up with one-channel microphone and automatically attenuates the low frequency level by using the second measure above. Patent Document 4 discloses a sound pickup apparatus and stereo conversion method that separate, in stereo sound-field creating processing, to a band including a wind noise component more and the other bands, and change the stereo sound-field creating processing to be performed on the band including a wind noise component more according to detecting wind noise (third measure above). Patent Document 4 further discloses an automatic wind noise reducing apparatus and method that perform automatic wind noise reducing processing compliant with multi-channel sound-field creating processing in picking-up with three or more channel microphones (first and second measures above).

Patent Document 5 discloses an audio processing circuit apparatus that can attenuate unnecessary wind noise component only, without reducing the low frequency component of audio to be picked-up. FIG. 15 shows the audio processing circuit apparatus disclosed in Patent Document 5. In FIG. 15, audios Rs and Ls and wind noises Lw and Rw of the right centered Rch and the left centered Lch are input to an Rch microphone 201 and an Lch microphone 202, respectively.

The Rch is connected to an analog delay circuit 205 which allows low frequencies to pass through in an LPF construction through an AMP 203 while the Lch for left audio signals is connected to an analog delay circuit 206 through an AMP 204. The output of the AMP 203 and output of the delay circuit 206 are connected to a subtracting circuit 207 to undergo subtraction processing. The output of the AMP 204 and output of the delay circuit 205 are connected to a subtracting circuit 208 to undergo subtraction processing. Basically and ideally, a right audio is only input to the right microphone 201 while a left audio is only input to the left microphone 202. However, because of the ability of the left and right microphones 202 and 201, the audio signals on the opposite side of each other may be mixed in picking-up. Especially, the use of omni-directional microphones may result in making a slight difference and therefore no sense of stereo. Accordingly, the audio processing apparatus 200 with this construction takes advantage of a difference in phases of audio signals picked-up by the two left and right microphones 202 and 201 to delay and subtract the audio signals output from the microphones from each other. Thus, the mixed and picked-up signal component is attenuated, and the channel separation can be improved.

If the wind noise component Rw is mixed with the Rch audio signal Rs of the right microphone 201 and the wind noise component Lw is mixed with the Lch audio signal Ls of the left microphone 202, the sound to be input to the right microphone 201 is Rs+Rw, which is amplified by the AMP 203. However, since the signal component does not change, the output of the AMP 203 is still Rs+Rw. On the other hand, the sound to be input to the left microphone 202 is Ls+Lw, which is amplified by the AMP 204. However, since the signal component does not change, the output of the AMP 204 is still Ls+Lw. These signals are input to the subtracting circuits 207 and 208 and the delay circuits 205 and 206 as they are.

Here, when LPFs functioning as the delay circuits 205 and 206 are used, the right signal Rs of the sound signal Rs+Rw, which is input to the delay circuit 205, may be considered as a right audio low frequency component RsL and a right audio high frequency component RsH separately. In other words, the delay circuit 205 outputs (RsL+RsH)+Rw while the output of Ls+Lw, which is input to the delay circuit 206 is (LsL+LsH)+Lw. However, since the delay circuits 205 and 206 are LPFs, the delay circuits 205 and 206 output an audio low frequency component without attenuation but reduce a higher frequency component. As a result, the outputs are LR+HR+WR and LL+HL+WL where the delayed RsL and LsL are LR and LL, and the high frequency components having reduced RsH and LsH are HR and HL.

Therefore, the signal, RsL+RsH+Rw−(LL+HL+WL) is input to the subtracting circuit 207, which outputs a signal a. The output signal a may be expressed as:
a=(RsL−LL)+(RsH−HL)+(Rw−WL) [EQ5]

Since the first and second terms of the EQ5 are audio signals, the output signal a may be handled as a synthesized signal of audio signals having a difference in phase. On the other hand, since the wind noise component may occur due to the constructional factor of the microphones 201 and 202 and mainly contain swirling airflow component, the wind noises picked-up by the left and right microphones 201 and 202 are not related to each other and cannot be handled as a synthesized signal. Therefore, the output signal a in EQ5 of the subtracting circuit 207 and the output signal b of the subtracting circuit 208 may be expressed as:
a=RL′+RH′+(Rw−WL) [EQ6]
b=LL′+LH′+(Lw−WR) [EQ7]
where (RsL−LL)=RL′ and (RsH−HL)=RH′.

The output signal a is divided into a high frequency component and a low frequency component in an LPF 210 and an HPF 209. The output signal c of the LPF 210 is an audio signal RL′+(Rw−WL) of the Rch low frequency component while the output signal e of the HPF 209 is RH′. The output signal c of the LPF 210 is input to an adder 213 and a fixed contact A of a switch 214. The output signal b is divided into a high frequency component and a low frequency component in an LPF 211 and an HPF 212. The output signal d of the LPF 211 is an audio signal LL′+(Lw−WR) of the Lch low frequency component while the output signal f of the HPF 212 is LH′. The output signal d of the LPF 211 is input to the adder 213 and a fixed contact D of the switch 214. The shown signal g is a synthesized audio signal of the Rch and Lch low frequency components including no wind noise component and is RL′+(Rw−WL)+LL′+(Lw−WR). The wind noise component is (RW+LW)−(WL+WR), and is reduced because of no conformity. Apparently, the remained component is the synthesized signal RL′+LL′ of the low components of the input audio signals. The output terminals E and F connecting to a movable armature that switches between the fixed contacts A and B and the fixed contacts C and D of the switch 214 selectively output a signal from the contact A or B or a signal from the contact D or C. The signals j and k output from the output terminals E and F of the switch 214 can be output from adders 215 and 216 to output terminals 217 and 218 by switching and selecting the signal c, g or d input from and in accordance with the fixed contact A, B, C or D of the switch 214.

Therefore, in response to an instruction for canceling the effect of reducing a wind noise component by manipulating the switch 214, the switch 214 connects the output terminal E to the contact A and output terminal F to the contact D, resulting in no wind noise reduction effect. In response to an instruction for activating the effect of reducing a wind noise component by manipulating the switch 214, the switch 214 connects the output terminal E to the contact B and output terminal F to the contact C, resulting in maximum wind noise reduction effect. In other words, the wind noise reduction effect is intermittently switchable and selectable as required by performing the switching operation with the switch 214.

The technologies disclosed in Patent Documents 1 to 4 are all wind noise reduction processing using the technical measures above. By the way, with the spread of high-definition TVs for future television broadcasting, high-definition recording and/or playing will be performed at households more easily, which may demand a sound pickup system that is compact but capable of high quality recording. For the low frequency component of audio to be picked-up, the audio processing apparatus disclosed in Patent document 5 has a circuit for improving the stereo separation in the previous stage also to be converted to monaural (that is, the low frequency signal RL′+LL′ is a monaural signal) during wind noise reduction.

Patent Document 1: Patent No. 3593860

Patent Document 2: JP-A-2001-186585

Patent Document 3: JP-A-2001-352594

Patent Document 4: JP-A-2003-299183

Patent Document 5: JP-A-10-32894

### SUMMARY OF THE INVENTION

Accordingly, it is desirable to propose a noise reducing apparatus, method and program and sound pickup apparatus for an electronic apparatus, which can more largely minimize wind noise than measures in the past by selecting signals from multiple microphones at the minimum criterion (minimizing) appropriately in each predetermined period of time and re-synthesizing as a wind noise reducing method especially suitable for recording with multiple microphones closely contained in a recent home digital video camera, for example.

According to an embodiment of the present invention, there is provided a noise reducing apparatus including an input section inputting multiple audio signals from multiple audio channels, multiple band extracting sections extracting a predetermined band from the multiple audio signals, a calculating section averaging signals from the multiple band extracting sections, multiple first level detecting sections detecting the signal levels in a predetermined period of time of the signals from the multiple band extracting sections, a second level detecting section detecting the signal level in a predetermined period of time of the signal from the calculating section, a selecting section selecting, for each of the predetermined period of times, the signal having the lowest level value of the level values detected by the multiple first level detecting sections and the second level detecting section, a band limiting section limiting the band of the signal from the selecting section, and a band synthesizing section band-synthesizing the signal from the band limiting section and the signal in a band, which is not extracted by the multiple band extracting sections, for each audio channel, wherein the output of the band synthesizing section is an audio channel output signal.

According to another embodiment of the invention, there is provided a noise reducing apparatus including an input section inputting multiple audio signals from multiple audio channels, multiple band extracting sections extracting a predetermined band from the multiple audio signals, a calculating section averaging signals from the multiple band extracting sections, multiple first level detecting sections detecting the signal levels in a predetermined period of time of the signals from the multiple band extracting sections, a second level detecting section detecting the signal level in a predetermined period of time of the signal from the calculating section, a selecting section selecting, in each audio channel and for each of the predetermined period of times, the signal having a lower level value between the level values from the multiple first level detecting sections and the level value from the second level detecting section, multiple band limiting sections limiting the band of the signal from the selecting section, and a band synthesizing section band-synthesizing the signal from the multiple band limiting sections and the signal in the band, which is not extracted by the multiple band extracting sections, for each audio channel, wherein the output of the band synthesizing section is an audio channel output signal.

According to another embodiment of the invention, there is provided a noise reducing method including the steps of inputting multiple audio signals from multiple audio channels, extracting a predetermined band from the multiple audio signals, averaging signals from the multiple band extracting steps, detecting a first signal level in a predetermined period of time of the signals from the multiple band extracting steps, detecting a second signal level in a predetermined period of time from the averaging step, selecting, for each of the predetermined period of times, the signal having the lowest level value of the level values detected by the first signal level detecting step and the second signal level detecting step, limiting the band of the signal from the selecting step, and band-synthesizing the signal from the band limiting step and the signal in a band, which is not extracted by the multiple band extracting steps, for each audio channel, wherein the output of the band synthesizing step is an audio channel output signal.

According to another embodiment of the invention, there is provided a noise reducing method including the steps of inputting multiple audio signals from multiple audio channels, extracting a predetermined band from the multiple audio signals, averaging signals from the multiple band extracting steps, detecting a first signal level in a predetermined period of time of the signals from the multiple band extracting steps, detecting a second signal level in a predetermined period of time of the signal from the averaging step, selecting, in each audio channel and for each of the predetermined period of times, the signal having a lower level value between the level values from the first signal level detecting step and the level value from the second signal level detecting step, limiting the bands of the signals from the selecting step, and band-synthesizing the signals from the multiple band limiting steps and the signal in the band, which is not extracted by the multiple band extracting steps, for each audio channel, wherein the output of each of the band synthesizing steps is an audio channel output signal.

According to another embodiment of the invention, there is provided a noise reducing program including an input section inputting multiple audio signals from multiple audio channels, multiple band extracting sections extracting a predetermined band from the multiple audio signals, a calculating section averaging signals from the multiple band extracting sections, multiple first levels detecting sections detecting the signal level in a predetermined period of time of the signals from the multiple band extracting sections, a second level detecting section detecting the signal level in a predetermined period of time of the signal from the calculating section, a selecting section selecting, for each of the predetermined period of times, the signal having the lowest level value of the level values detected by the multiple first level detecting sections and the second level detecting section, a band limiting section limiting the band of the signal from the selecting section, and a band synthesizing section band-synthesizing the signal from the band limiting section and the signal in a band, which is not extracted by the multiple band extracting sections, for each audio channel, wherein the output of the band synthesizing section is an audio channel output signal.

According to another embodiment of the invention, there is provided a noise reducing program including an input section inputting multiple audio signals from multiple audio channels, multiple band extracting sections extracting a predetermined band from the multiple audio signals, a calculating section averaging signals from the multiple band extracting sections, multiple first level detecting sections detecting the signal levels in a predetermined period of time of the signals from the multiple band extracting sections, a second level detecting section detecting the signal level in a predetermined period of time of the signal from the calculating section, a selecting section selecting, in each audio channel and for each of the predetermined period of times, the signal having a lower level value between the level values from the multiple first level detecting sections and the level value from the second level detecting section, multiple band limiting sections limiting the bands of the signals from the selecting section, and a band synthesizing section band-synthesizing the signals from the multiple band limiting sections and the signal in the band, which is not extracted by the multiple band extracting sections, for each audio channel, wherein the output of the band synthesizing section is an audio channel output signal.

According to another embodiment of the invention, there is provided a sound pickup apparatus for electronic equipment that picks up multiple audio signals from multiple audio channels, the apparatus including multiple band extracting sections extracting a predetermined band from multiple audio signals, a calculating section averaging signals from the multiple band extracting sections, multiple first level detecting sections detecting the signal levels in a predetermined period of time of the signals from the multiple band extracting sections, a second level detecting section detecting the signal level in a predetermined period of time of the signal from the calculating section, a selecting section selecting, for each of the predetermined period of times, the signal having the lowest level value of the level values detected by the multiple first level detecting sections and the second level detecting section, a band limiting section limiting the band of the signal from the selecting section, and a band synthesizing section band-synthesizing the signal from the band limiting section and the signal in a band, which is not extracted by the multiple band extracting sections, for each audio channel, wherein the output of the band synthesizing section is an audio channel output signal.

According to another embodiment of the invention, there is provided a sound pickup apparatus for electronic equipment that picks up multiple audio signals from multiple audio channels, the apparatus including multiple band extracting sections extracting a predetermined band from the multiple audio signals, a calculating section averaging signals from the multiple band extracting sections, multiple first level detecting sections detecting the signal levels in a predetermined period of time of the signals from the multiple band extracting sections, a second level detecting section detecting the signal level in a predetermined period of time of the signal from the calculating section, a selecting section selecting, in each audio channel and for each of the predetermined period of times, the signal having a lower level value between the level values from the multiple first level detecting sections and the level value from the second level detecting section, multiple band limiting sections limiting the bands of the signals from the selecting section, and a band synthesizing section band-synthesizing the signal from the multiple band limiting sections and the signal in the band, which is not extracted by the multiple band extracting sections, for each audio channel, wherein the output of the band synthesizing section is an audio channel output signal.

According to the embodiments of the invention, since minimum (or minimum value) selecting processing is performed in wind noise reduction processing that performs monaural conversion (averaging) in the past, the only in-phase component included in multiple signals can be strongly extracted. The strongly related signals such as imageable sound signals from contained microphones of a video camera, for example, may be extracted as an in-phase component while unrelated signals such as wind noise signals are largely removed. Thus, a noise reducing apparatus, method and program and sound pickup apparatus for electronic equipment can be obtained which can increase the effect of reducing the wind noise component.

Though in the prior arts the averaged band becomes monaural in wind noise reduction processing performing monaural conversion (averaging), according to the embodiments of the invention, minimum (or minimum value) selecting processing is performed on an audio signal of each channel and a monaural-converted (averaged) signal. Thus, a noise reducing apparatus, method and program and sound pickup apparatus for electronic equipment which can maintain the sense of the sound field (separation) of each audio channel along with reducing wind noise, are obtained.

According to the embodiments of the invention, the minimum (minimum value) selecting processing is performed to the prior arts wind noise reducing processing performing monaural conversion (averaging). Thus, only in-phase components included in multiple signals can be strongly extracted. Therefore, strongly related signals such as imageable sound signals from internal microphones of a video camera can be extracted as in-phase components, and unrelated signals such as wind noise signals can be largely removed. As a result, a noise reducing apparatus, method and program and sound pickup apparatus for electronic equipment thereof can be obtained which can increase the effect of reducing the wind noise component.

While in the prior arts the wind noise reduction processing performing monaural conversion (averaging) converts the averaged band to monaural, the embodiments of the invention performs minimum (minimum value) selecting processing on an audio signal of each channel and monaural-converted (averaged) signal. As a result, a noise reducing apparatus, method and program and sound pickup apparatus for electronic equipment thereof can be obtained which can keep the sense of sound field (separation) of each audio channel along with reducing wind noise.

According to the embodiments of the invention, an LPF extracts a wind noise band for each audio channel, and the wind noise band is divided into multiple bands, each of which undergoes minimum (minimum value) selecting processing by multiple LPFs and BPFs. Thus, a noise reducing apparatus, method and program and sound pickup apparatus for electronic equipment thereof can be obtained which can achieve good reproducibility of the audio signal of each audio channel along with reducing wind noise.

According to the embodiments of the invention, the extracted wind noise band is converted to a frequency signal by using an FFT section, and each frequency signal undergoes minimum (minimum value) selecting processing. Thus, a noise reducing apparatus, method and program and sound pickup apparatus for electronic equipment thereof can be obtained which can achieve good reproducibility of the audio signal of each audio channel along with reducing wind noise.

According to the embodiments of the invention, the minimum time unit for performing the minimum (minimum value) selecting processing is a sampling time for a digital signal. In consideration of the fact that a wind noise band is generally a band of 1 kHz or lower, the minimum sampling frequency is 2 kHz based on the sampling theorem (Nyquist theorem), and the longest predetermined time may be extended up to 0.5 ms. Thus, a noise reducing apparatus, method and program and sound pickup apparatus for electronic equipment therefore can be obtained which can select the time length for performing the minimum (minimum value) selecting processing of the embodiments of the invention from 1/Fs to 0.5 ms.

According to the embodiments of the invention, a noise reducing apparatus, method and program and sound pickup apparatus for electronic equipment thereof can be obtained which can adjust the reduction effect by controlling the mix ratio of the output signal of the wind noise reducing processing and the input signal before the processing and can implement automatic wind noise reducing processing by adjusting the mix ratio based on the wind noise level.

Furthermore, a noise reducing apparatus, method and program and sound pickup apparatus for electronic equipment thereof can be obtained which can have a higher wind noise reduction effect than prior arts even when the combination of the wind noise reducing processing of the invention and the conventional wind noise reducing processing is implemented.

### BRIEF DESCRIPTION OF THE DRAWINGS

FIG. 1 is a block diagram showing a noise reducing apparatus according to a first embodiment of the invention;

FIG. 2 is a block diagram of a level value detecting/determining section for use in a noise reducing apparatus according to the embodiment of the invention;

FIGS. 3A to 3E show operational waveform diagrams for describing a wind noise reducing method of a noise reducing apparatus according to the embodiment of the invention;

FIG. 4 is a flowchart by a level value detecting/determining section for use in a noise reducing apparatus according to the embodiment of the invention;

FIG. 5 is a block diagram showing a noise reducing apparatus according to a second embodiment of the invention;

FIGS. 6A to 6G are operational waveform diagrams for describing a wind noise reducing method of a noise reducing apparatus according to the second embodiment of the invention;

FIG. 7 is a block diagram showing a noise reducing apparatus according to a third embodiment of the invention;

FIG. 8 is a band frequency characteristic curve diagram showing divided bands of the third embodiment;

FIG. 9 is a block diagram showing a noise reducing apparatus according to a fourth embodiment of the invention;

FIG. 10 is a specific block diagram showing an automatic noise reducing apparatus according to another embodiment of the invention;

FIG. 11 is a block diagram showing a noise reducing apparatus according to a fifth embodiment of the invention;

FIG. 12 is a schematic block diagram of an automatic noise reducing apparatus according to another embodiment of the invention;

FIG. 13 is a block diagram schematically showing an automatic noise reducing apparatus in the prior arts;

FIG. 14 is a frequency characteristic curve diagram for describing a wind noise component; and

FIG. 15 is a block diagram showing another construction of an automatic noise reducing apparatus in the prior arts.

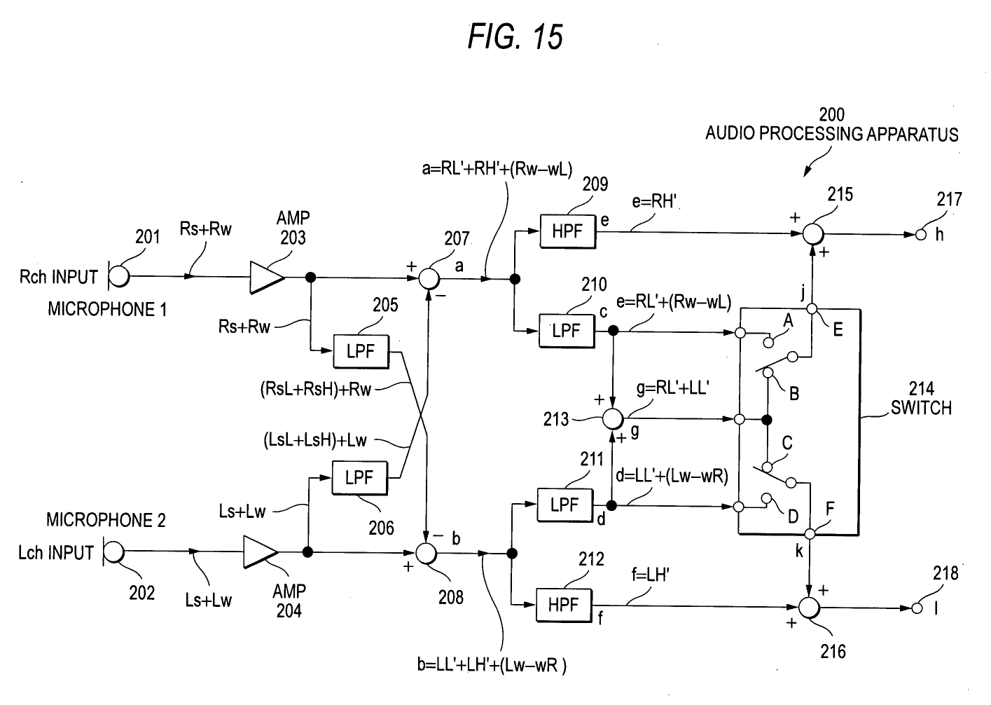

### DESCRIPTION OF THE PREFERRED EMBODIMENTS

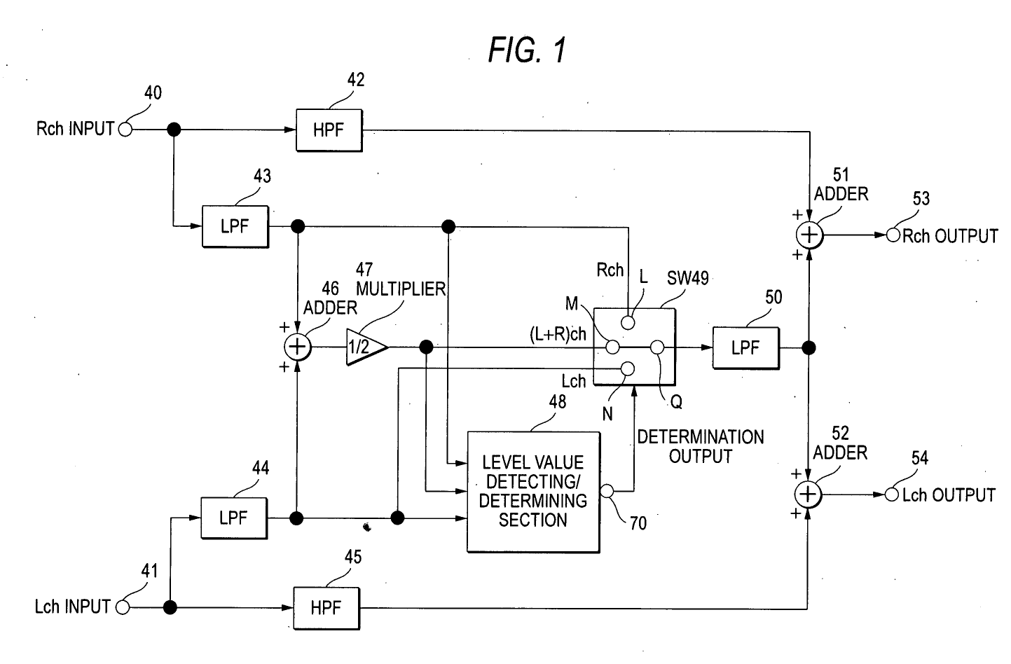

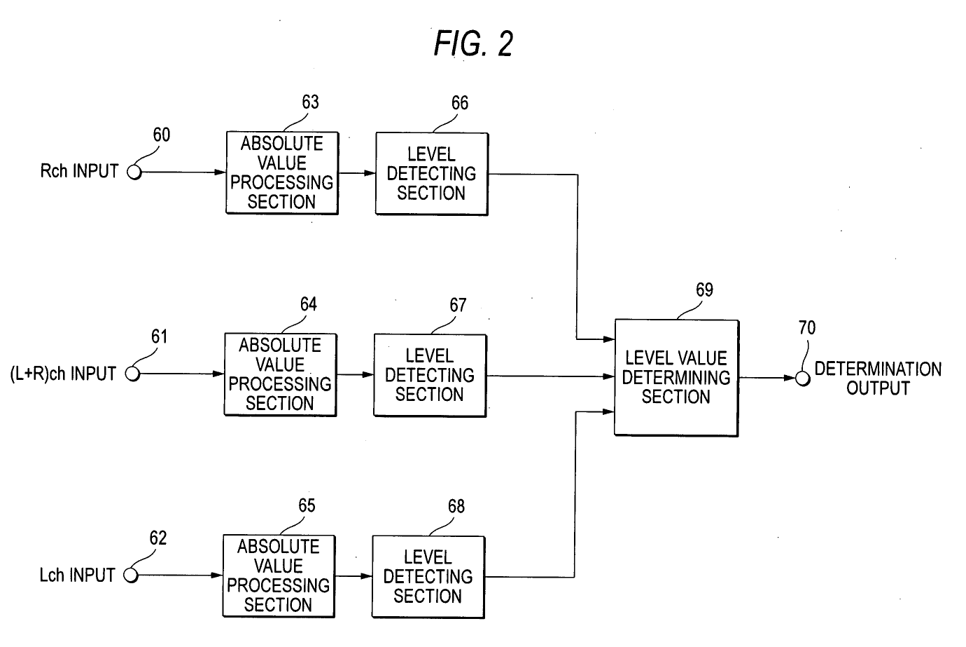

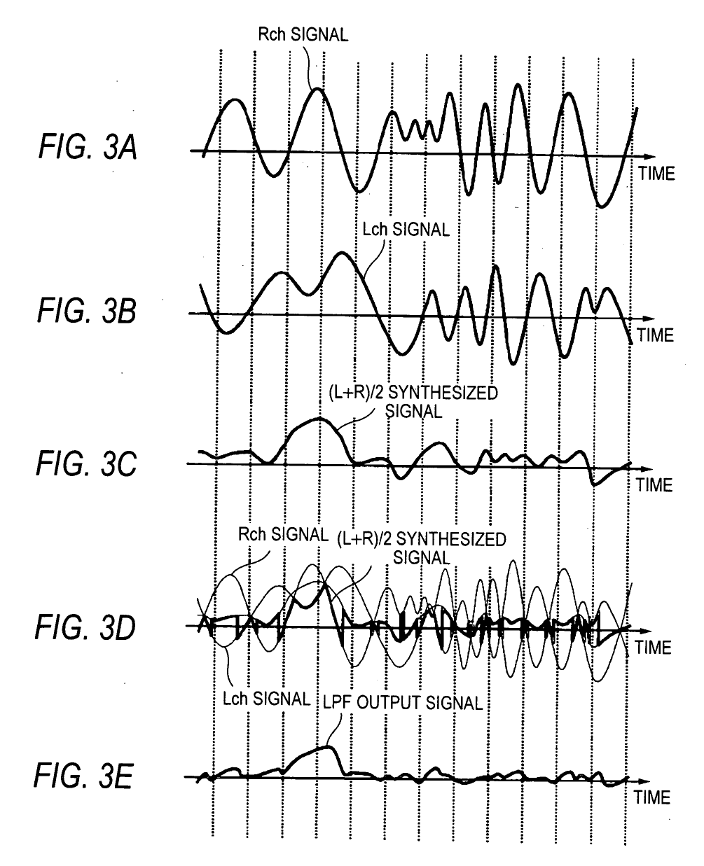

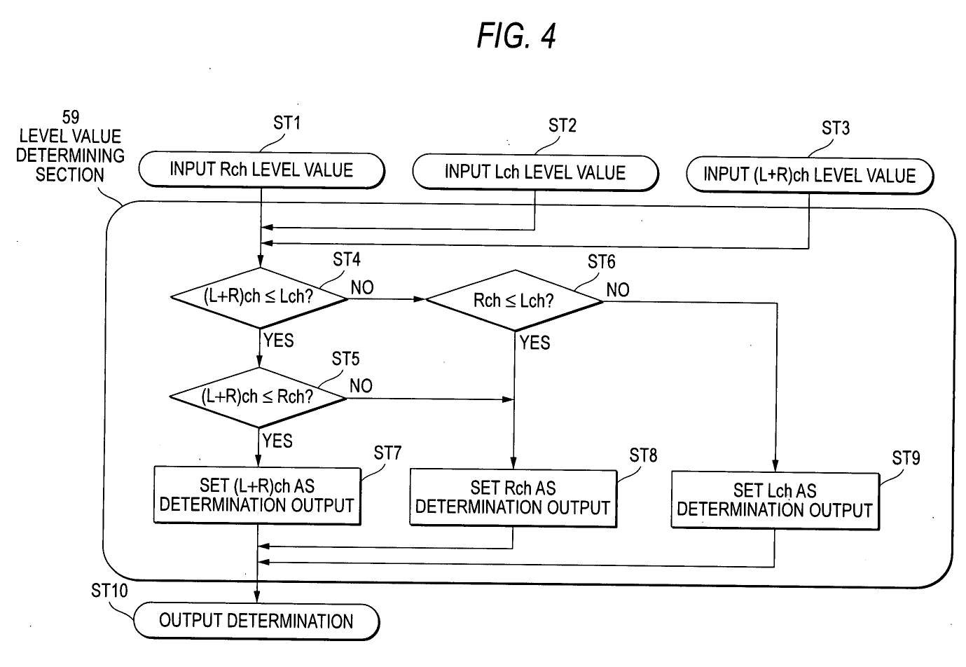

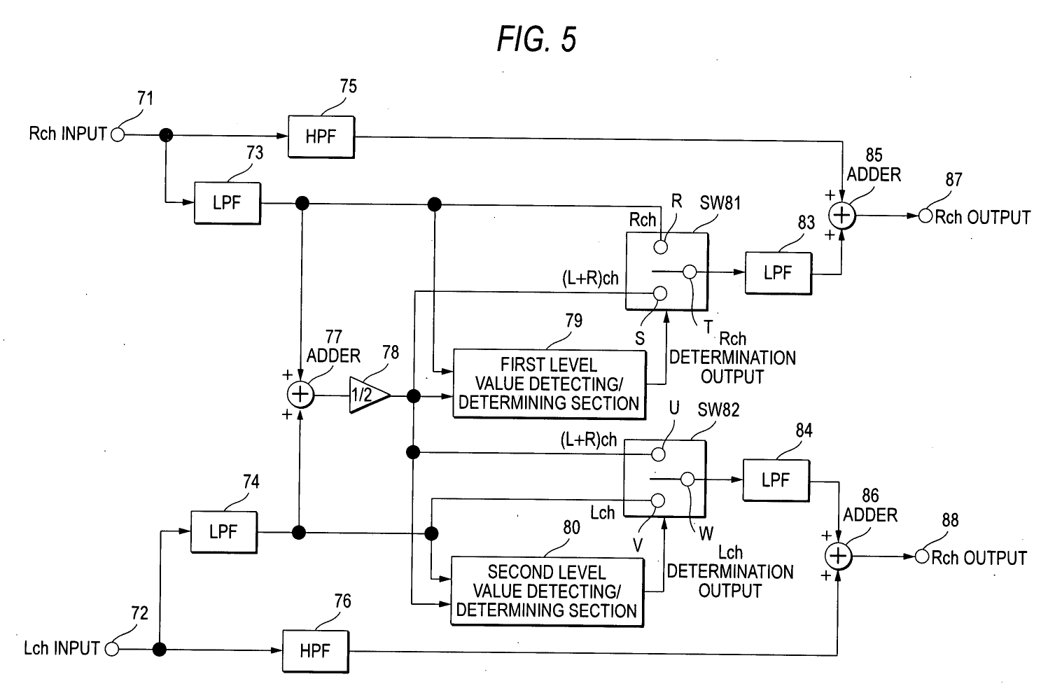

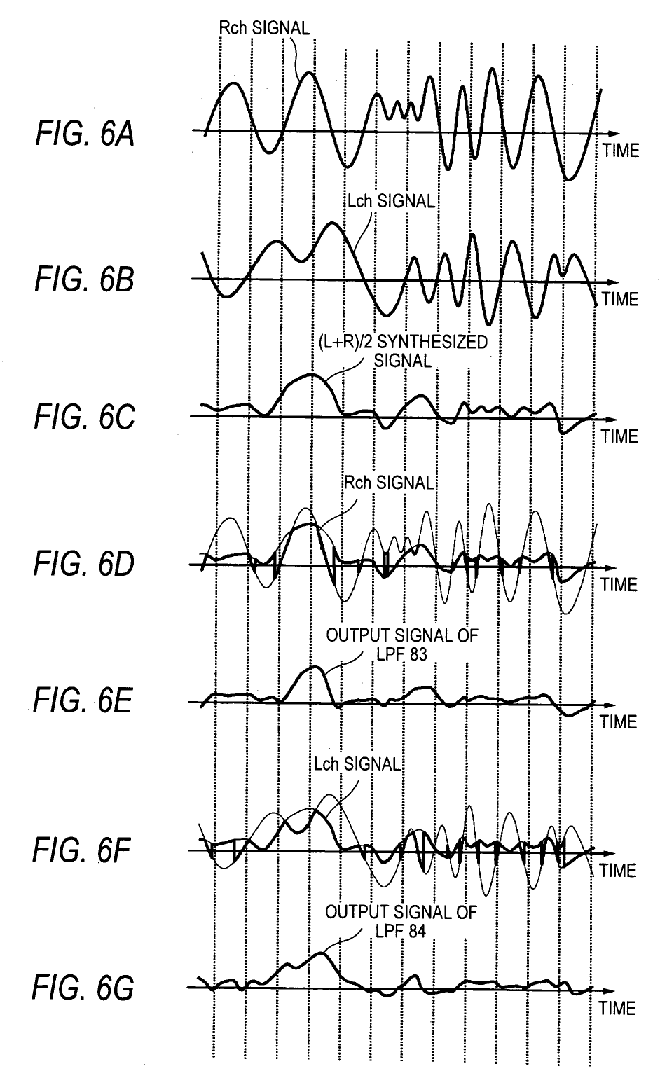

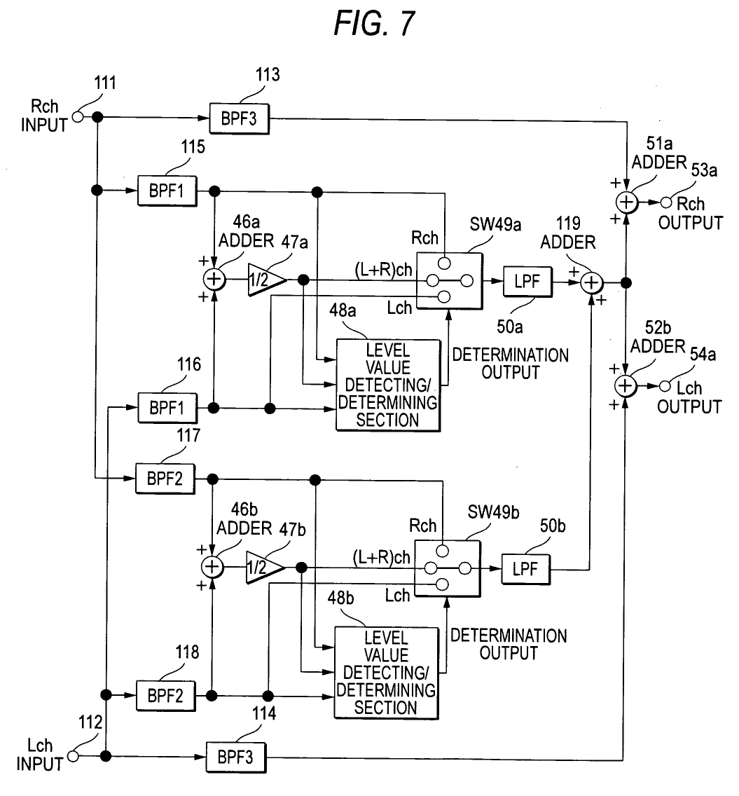

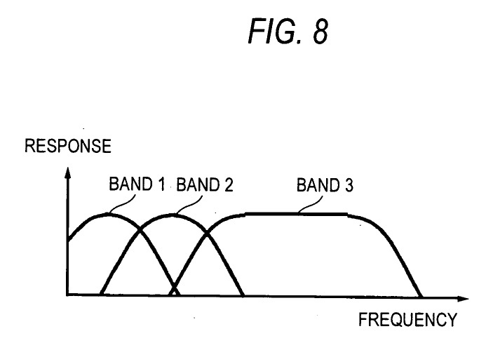

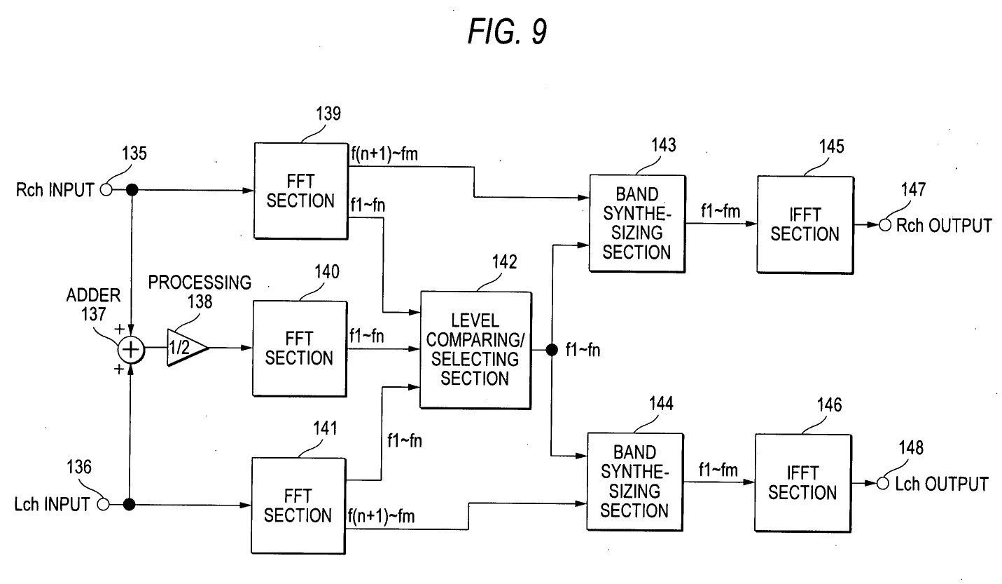

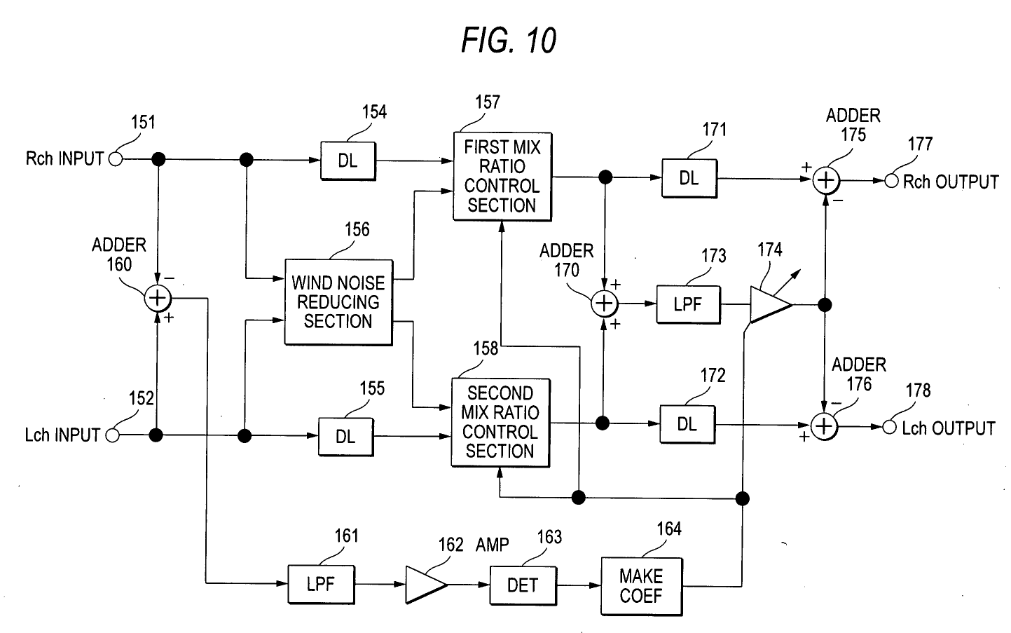

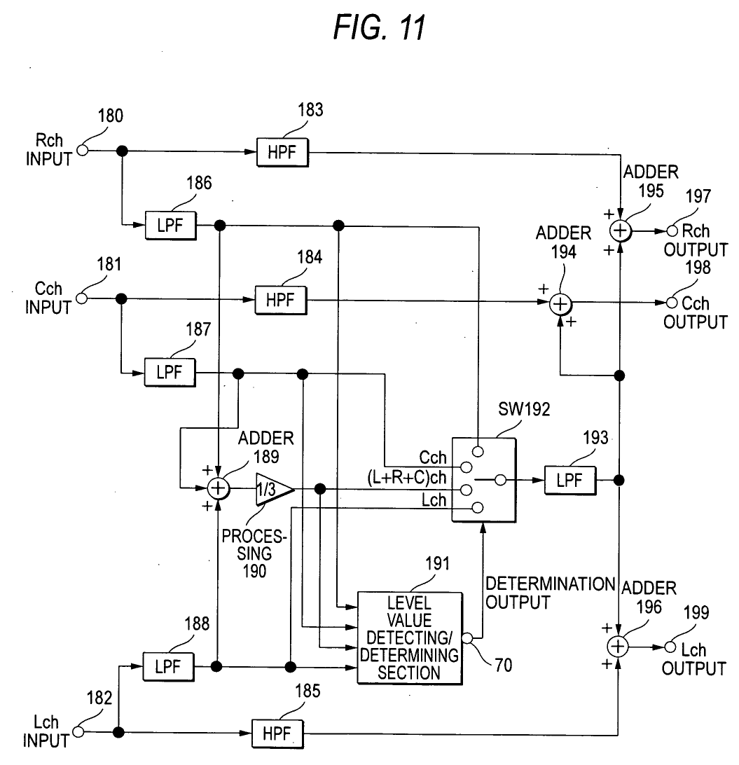

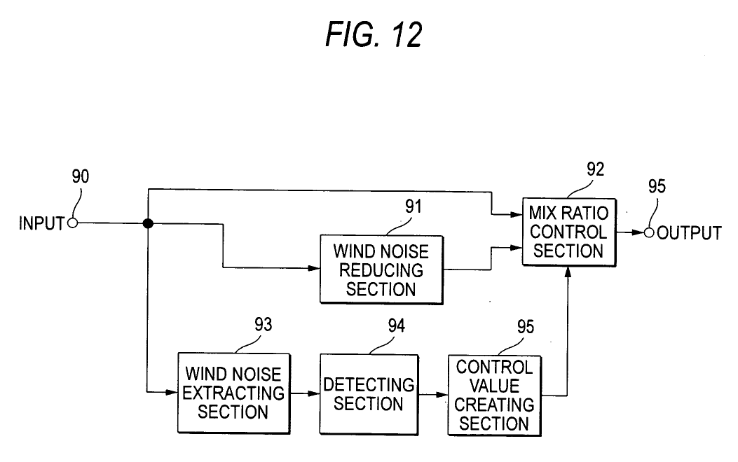

Embodiments of the invention will be described below with reference to FIGS. 1 to 12. FIG. 1 is a block diagram showing a noise reducing apparatus according to a first embodiment of the invention; FIG. 2 is a block diagram of a level value detecting/determining section for use in a noise reducing apparatus according to the embodiment of the invention; FIGS. 3A to 3E show operational waveform diagrams for describing a wind noise reducing method of a noise reducing apparatus according to the embodiment of the invention; FIG. 4 is a flowchart by a level value detecting/determining section for use in a noise reducing apparatus according to the embodiment of the invention; FIG. 5 is a block diagram showing a noise reducing apparatus according to a second embodiment of the invention; FIGS. 6A to 6G are operational waveform diagrams for describing a wind noise reducing method of a noise reducing apparatus according to the second embodiment of the invention; FIG. 7 is a block diagram showing a noise reducing apparatus according to a third embodiment of the invention; FIG. 8 is a band frequency characteristic curve diagram showing divided bands of the third embodiment; FIG. 9 is a block diagram showing a noise reducing apparatus according to a fourth embodiment of the invention; FIG. 10 is a block diagram showing an automatic noise reducing apparatus according to an embodiment of the invention; FIG. 11 is a block diagram showing a noise reducing apparatus according to a fifth embodiment of the invention; and FIG. 12 is a schematic block diagram of an automatic noise reducing apparatus according to another embodiment of the invention.

With reference to FIGS. 1 to 12, embodiments of the invention will be described below. First of all, with reference to FIG. 1, a noise reducing apparatus according to an embodiment of the invention will be described. FIG. 1 shows a two-channel wind noise reducing apparatus. Rch and Lch signals input from terminal 40 and 41 are input to an HPF 42 and an LPF 43 and an HPF 45 and an LPF 44, respectively. The Rch low frequency signal from the LPF 43 and the Lch low frequency signal from the LPF 44 are input to an adder 46, a level value detecting/determining section 48 and fixed contacts L and N of a switch (SW) 49, respectively. The output of the adder 46 is multiplied by ½ by a multiplier 47 and is input, as a (L+R)ch signal, to the level value detecting/determining section 48 and a fixed contact M of the SW 49.

Referring to FIG. 2, a block construction of the level value detecting/determining section 48 will be described. In FIG. 2, the Rch, (L+R)ch and Lch signals from terminals 60, 61 and 62 may be converted to positive absolute values, for example, by absolute value processing sections 63, 64 and 65, and the respective levels are detected by level detecting sections 66, 67 and 68. A level value determining section 69 in the subsequent stage compares the respective level values, and the determination result is output from a determination output terminal 70.

Here, referring to FIG. 1, a movable armature of the SW 49 is switched to select one of the Rch, (L+R)ch and Lch, which is then added to the output of the HPF 42 by an adder 51 through an LPF 50. Then, the Rch signal is output from an output terminal 53. In the same manner, the selected one is added to the output of the HPF 45 by an adder 52, and the Lch signal is output from an output terminal 54.

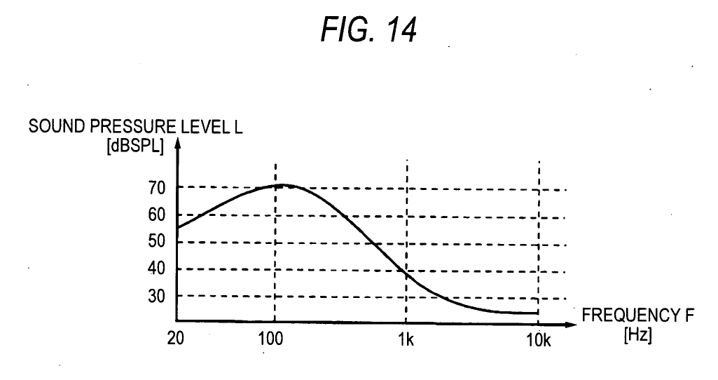

Referring to FIGS. 3A to 3E, operations of the level value detecting/determining section 48 in FIG. 1 will be described. First of all, the LPFs 43 and 44 allow the wind noise bands shown in FIG. 14 to pass through. Here, the output of the LPF 43 and the output of the LPF 44 are Rch and Lch signals shown in FIGS. 3A and 3B, respectively. The processing by the adder 46 and the multiplication processing by ½ by the multiplier 47 thereon generate a (L+R)/2 synthesized signal shown in FIG. 3C. As shown in FIG. 2, in the level value detecting/determining section 48, signals input to the output terminals 60, 61 and 62 are compared in levels by the level value determining section 69 through the absolute value processing sections 63, 64 and 65 and the level detecting sections 66, 67 and 68. Now, the operations by the level value determining section 69 will be described with reference to the flowchart in FIG. 4.

Referring to FIG. 4, in a first step ST1, an Rch signal is input to the input terminal 60, and the absolute value processing section 63 and level detecting section 66 detect the Rch signal level value. In a second step ST2, an Lch signal is input to the input terminal 62, and the absolute value processing section 65 and level detecting section 68 detect the Lch signal level value. In a third step ST3, the (L+R)ch synthesized signal is input to the input terminal 61, and the absolute value processing section 64 and level detecting section 67 detect the (L+R)ch synthesized signal level value.

After the completion of the first to third steps ST1 to ST3, the processing moves to a fourth step ST4 where whether (L+R)ch synthesized signal≦Lch signal or not is determined in the level value determining section 69. If “NO”, the processing moves to a sixth step ST6 where whether Rch signal ≦Lch signal or not is determined. If “YES” in the fourth step ST4, the processing moves to a fifth step ST5 where whether (L+R)ch synthesized signal≦Rch signal or not is determined. If “YES” in the fifth step ST5, the processing moves to a seventh step ST7 where (L+R)ch synthesized signal is defined as the determination output. If “NO”, the processing moves to an eighth step ST8 where the Rch signal is defined as the determination output. If “YES” in the sixth step ST6, the processing moves to the eighth step ST8 where the Rch signal is defined as the determination output. If “NO” in the sixth step ST6, the processing moves to a ninth step ST9 where the Lch signal is defined as the determination output. After the completion of the seventh to ninth steps ST7 to ST9, the processing moves to a tenth step ST10 where the determination output is output to a determination output terminal 70.

In this way, the signal with the lowest level is typically selected to output to the output terminal 70. Referring to FIG. 1, when the determination output of the determination output terminal 70 is input to the SW 49 to select the lowest signal, the signal at the lowest level is selected and output from the Rch signal in FIG. 3A, Lch signal in FIG. 3B and (L+R)/2 synthesized signal in FIG. 3C as indicated by the thick line in FIG. 3D. Furthermore, through the LPF 50 for suppressing the harmonic component, it is output as shown in FIG. 3E. Then, the output is added to the signals of the bands which are not a wind noise band, from the HPFs 42 and 45, by adders 51 and 52 for band re-synthesis, whereby Rch and Lch signals with reduced wind noise are generated.

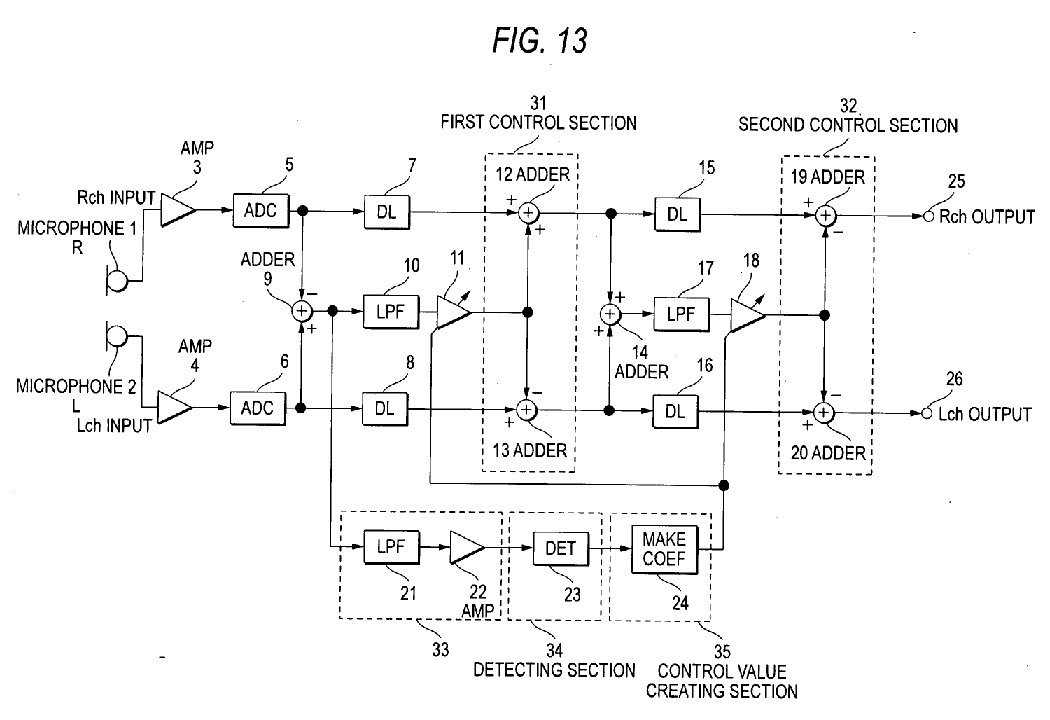

By the way, the measures against wind noise in the prior arts include the monaural conversion of multi-channel signals, and the first control section 31 in the part enclosed by the broken lines in FIG. 13 performs the processing of monaural converting 2-ch signals. Here, the (L+R)ch signal in FIG. 3C is a monaural signal and may be a signal after the wind noise measure in the prior arts. However, the signal in FIG. 3E, which is a signal after the wind noise measure according to an embodiment of the invention, has a level more greatly reduced than the signal in FIG. 3C. The components unrelated between/among channels such as a wind noise component are strongly removed, and the components strongly related between/among channels such as imageable sound signals are only extracted.

Next, a two-channel wind noise reducing apparatus according to a second embodiment of the invention will be described. In the block diagram shown in FIG. 5, wind noise is reduced without the monaural conversion of a wind noise band unlike the wind noise reducing apparatus in FIG. 1. First of all, Rch and Lch signals input from input terminals 71 and 72 are input to an HPF 75 and an LPF 73 and an HPF 76 and an LPF 74, respectively. The Rch low frequency signal from the LPF 73 is input to an adder 77, a first level value detecting/determining section 79 and a fixed contact R of an SW 81. The Lch low frequency signal from the LPF 74 is input to an adder 77, a second level value detecting/determining section 80 and a fixed contact V of an SW 82.

The output of the adder 77 is multiplied by ½ by a multiplier 78 and is input, as a (L+R)ch signal, to the first and second level value detecting/determining sections 79 and 80 and fixed contacts S and U of the SWs 81 and 82. Here, the first and second level value detecting/determining sections 79 and 80 determine properly an input signal at a lower level in the same manner as that of the level value detecting/determining section 48 and output the signals as Rch and Lch determination outputs to respective SWs 81 and 82. The output determined by the SWs 81 and 82 are selected and added to the outputs of the HPFs 75 and 76 by adders 85 and 86 through LPFs 83 and 84 and are output as Rch and Lch signals from output terminals 87 and 88, respectively.

Now, operations of the noise reducing apparatus with the construction shown in FIG. 5 will be described with reference to signal waveforms in FIGS. 6A to 6G. First of all, the LPFs 73 and 74 allow the input signals to be supplied to the input terminals 71 and 72 to pass through the wind noise bands shown in FIG. 14. The output of the LPF 73 and the output of the LPF 74 are Rch and Lch signals shown in FIGS. 6A and 6B, respectively. The processing by the adder 77 and the multiplication processing by ½ by the multiplier 78 thereon generates a (L+R)/2 synthesized signal shown in FIG. 6C. The first level value detecting/determining section 79 and SW 81 typically select the lowest value of the Rch signal shown in FIG. 6A and the (L+R)/2 synthesized signal shown in FIG. 6C, and the Rch signal is output as indicated by the thick line in FIG. 6D. Furthermore, through the LPF 83 for suppressing the harmonic component, it is output as the minimized Rch signal shown in FIG. 6E. In the same manner, when the minimum value of the Lch signal shown in FIG. 6B and the (L+R)/2 synthesized signal shown in FIG. 6C is selected by the second level value detecting/determining section 80 and SW 82, the minimized Lch signal is output as indicated by the thick line shown in FIG. 6F. Through the LPF 84 for suppressing the harmonic component, it is output as the minimized signal shown in FIG. 6G. Then, the Lch and Rch signals minimized by the LPFs 83 and 84 are added to the signals of the bands which are not a wind noise band, from the HPFs 75 and 76, by the adders 85 and 86 for band re-synthesis, whereby Rch and Lch signals with reduced wind noise are generated.

In this way, according to the second embodiment, the level of the wind noise component can be more reduced as shown in FIGS. 6E and 6G, and the Lch and Rch signal components can be left without monaural conversion in comparison with the (L+R)/2 synthesized signal in FIG. 6C generated by a wind noise reducing apparatus in the prior arts.

Now, a sampling interval for selecting a minimum value and a band-limited frequency thereafter according to an embodiment of the invention will be described. While, in FIGS. 3D and FIGS. 6D and 6F, the time unit for selecting a minimum value by level comparison is defined as a sampling interval, which is a minimum time unit of a digital signal, the band-limited frequency in the subsequent stage here may be defined to the one equal to or lower than Fs/2 by the sampling theorem where the sampling frequency is Fs. However, since the wind noise band is generally a low frequency of 1 kHz or lower as shown in FIG. 14, the sampling period for the minimum value selection may be increased up to the order of 0.5 ms (2 kHz). In other words, the level detection may be performed every 0.5 ms maximum, and the minimum level signal of the period may be selected.

Next, a noise reducing apparatus according to a third embodiment of the invention will be described with reference to the block diagram in FIG. 7. The same reference numerals with letters a and b are given to the corresponding components as those of the noise reducing apparatus in the block diagram shown in FIG. 1 and the detail description will be omitted herein. As indicated by the frequency band characteristic curb shown in FIG. 8, FIG. 7 includes a band 3, which is not a wind noise band, and the case that the wind noise band frequency is divided in bands into bands 1 and 2 will be described.

The Rch and Lch signals input from input terminals 111 and 112 are first divided in bands by band pass filters (called BPFs 1-115 and 1-116, BPFs 2-117 and 2-118 and BPFs 3-113 and 3-114), and each of the wind noise band frequencies of the band 1 and 2 is processed by the BPFs 1-115 and 1-116 and BPFs 2-117 and 2-118. First of all, the minimum value of the Rch and Lch signals from the BPFs 1-115 and 1-116 and the (L+R)ch signal from the adder 46a and multiplier 47a is selected by the level value detecting/determining section 48a and SW 49a and is input to an adder 119 through the LPF 50a. In the same manner, the minimum value of the Lch and Rch signals from the BPFs 2-117 and 2-118 and the (L+R)ch signal from the adder 46b and multiplier 47b is selected by the level value detecting/determining section 48b and SW 49b and is input to the adder 119 through the LPF 50b. The bands 1 and 2 are synthesized by the adder 119, and the result is further synthesized with the band 3 from the HPFs 3-113 and 3-114 by the adders 51a and 52b. Then, the Rch and Lch signals are output from the output terminals 53a and 54b, respectively. The minimum value selecting processing for each of divided bands can achieve wind noise reduction with enhanced reproducibility of in-phase audio signals Having described the case that the wind noise band frequency is divided into the bands 1 and 2 according to the third embodiment, the wind noise band frequency may be divided into more bands for processing.

FIG. 9 shows a noise reducing apparatus according to a fourth embodiment of the invention in which the reproducibility of audio signals is more enhanced than the third embodiment described with reference to FIG. 7 by performing fast Fourier transform (called FFT hereinafter). Here, Rch and Lch signals input from input terminals 135 and 136, which are time axis signals in audio bands, are converted to m frequency axis signals at frequencies f1 to fm by FFT sections 139 and 141, respectively. The (L+R)ch synthesized signal from an adder 137 and a ½ multiplier 138 is also converted to m frequency axis signals at the frequencies f1 to fm by an FFT section 140. Here, each of the FFT sections 139, 140 and 141 divides the frequency axis signals at the frequencies f1 to fm into frequencies f1 to fn of a wind noise band and frequencies f (n+1) to fm of the other bands, and the Rch and Lch signals and (L+R)ch signal at the frequencies f1 to fn are input to a level comparing/selecting section 142. The level comparing/selecting section 142 performs an operation of level comparison for each of the frequencies f1 to fn and selection of a signal at a channel with the lowest level on all of the frequencies f1 to fn.

Then, the selected signal is input to band synthesizing sections 143 and 144, is synthesized in bands with the signals at the frequencies f (n+1) to fm, and is transmitted to inverted fast Fourier transform (called IFFT) sections 145 and 146 as signals at the frequency f1 to fm. The frequency axis signals are inversely converted to time axis signals and are output from terminals 147 and 148 as Rch and Lch signals.

Having described the construction for wind noise reduction in two Lch and Rch channels, the invention is applicable to multi-channels including three or more channels. With reference to FIG. 11, a three-channel noise reducing apparatus according to a fifth embodiment of the invention will be described. First of all, Rch, center channel (called Cch hereinafter) and Lch signals are input from input terminals 180, 181 and 182 and are divided in bands into a wind noise band and a non wind noise band by an HPF 183 and an LPF 186, an HPF 184 and an LPF 187 and an HPF 185 and an LPF 188, respectively. The wind noise band signals Rch, Cch and Lch from the LPFs are input to an SW 192 and a level value detecting/determining section 191.

The outputs from the LPFs 186, 187 and 188 are also input to an adder 189 and are all added therein. Then, the result undergoes multiplication processing in a ⅓ multiplier 190 and is averaged therein. Then, the result is input as a (L+R+C)ch signal to an SW 192 and a level value detecting/determining section 191. The level value detecting/determining section 191 determines a signal at the lowest level in each predetermined sampling period. The SW 192 selects the signal. Adders 195, 194 and 196 band-synthesizes the selected signal with non wind noise band signals from the HPFs 183, 184 and 185 of the channels, and the results are output from output terminals 197, 198 and 199 as Rch, Cch and Lch signals.

The wind noise reduction processing can be performed for four or more channels by changing the averaging processing of the channels and performing the minimum-value selecting processing in the same manner. Like the second embodiment, the wind noise reduction processing with enhanced separation among channels may be achieved also in the third to fifth embodiments by performing the minimum-value selecting processing on the averaged signal of all channels and the channel signals. As described above, the wind noise reducing apparatus according to the embodiments of the invention can enhance the wind noise reduction effect more than prior arts, and the separation between/among channels can be maintained. Furthermore, wind noise may be automatically detected and reduced in combination with the technologies in the prior arts.

The automated case will be described with reference to a block diagram thereof in FIG. 12. In FIG. 12, an input signal from an input terminal 90 is input to a mix ratio control section 92, a wind noise reducing section 91 according to the first to fifth embodiments of the invention and a wind noise extracting section 93. Here, the signal input to the wind noise extracting section 93 is used as a control value for controlling the mix ratio control section 92 through a detecting section 94 and a control value creating section 95. These components are configured in the same manner as the wind noise extracting section 33, detecting section 34 and control value creating section 35 in the parts enclosed by the broken lines in FIG. 13. The mix ratio control section 92 controls the maximum ratio of the output of the wind noise reducing section 91 to 100% with large wind noise in the mix ratio of the input signal and the output signal of the wind noise reducing section 91. On the other hand, the mix ratio control section 92 controls the mix ratio of the input signal to 100% with no wind noise. Thus, the automation can be achieved. As shown in FIG. 13, the second control section 33 may be also used when the wind noise reducing section 91 according to the first to fifth embodiments of the invention serves as the first control section 31.

The automatic wind noise reducing apparatus in this case will be described with reference to FIG. 10, which is a specific block diagram thereof. The Rch and Lch audiosignals including wind noise signals, which are input from terminals 151 and 152, are input to a delay unit (DL) 154 and the minus terminal of the adder 160 and a DL 155 and the plus terminal of the adder 160, respectively. The adder 160 calculates the difference component (L−R) signal of both and inputs the result to an LPF 161. Since wind noise signals are not related between L and R channels, a large amount of the wind noise component may be extracted in the difference component (L−R) signal. The wind noise signals only, which hardly include imageable sound signals, may be extracted by passing only the low frequency component through the LPF 161 (wind noise extracting section 93 in FIG. 12). Furthermore, the output of the LPF 161 is amplified by an AMP 162, and the level of the wind noise signals is detected by a detecting unit (DET) 163 (detecting section 94 in FIG. 12). A control coefficient creating unit (MAKECOEF) 164 (control value creating unit 95 in FIG. 12) brings a control coefficient to be created, and a wind noise level detection signal with an attack/recovery time constant can be obtained.

The signal processed by the wind noise reducing section 156 according to the first to fifth embodiments of the invention is controlled in level with a wind noise level detection signal by the first and second mix ratio control sections 157 and 158. In this case, the first and second mix ratio control sections 157 and 158 control the mix ratio of the output of the wind noise reducing section 156 to 100% with large wind noise or with a high level of the wind noise level detection signal and, on the other hand, controls the level of the wind noise level detection signal to zero and the outputs of the DLs 154 and 155 to 100% (mix ratio control section 92 in FIG. 12). The outputs of the first and second mix ratio control sections 157 and 158 are input to the DLs 171 and 172, respectively, and are input to an adder 170, whereby both of them are added. Then, the output is input to an LPF 173.

The LPF 173 is set for the band for extracting a wind noise band. The output of the LPF 173 is controlled in level by a level adjusting unit 174 with the wind noise level detection signal from the MAKECOFE 164, and is controlled to be large when the level of the wind noise level detection signal is large and is controlled to be zero when the level of the wind noise level detection signal is zero because of no wind noise. The output of the level adjusting unit 174 is subtracted by an adder 175 from the signal through a DL 171 and is subtracted by an adder 176 from the signal through a DL 172 (second control section 32 in FIG. 13). The outputs of the adders 175 and 176 are output from output terminals 177 and 178 as respective Rch and Lch signals. In this way, the combination of the wind noise reducing section 156 according to an embodiment of the invention and the processing for reducing a wind noise band in the prior arts can further enhance the reduction effect.

Like the example in the prior arts shown in FIG. 13, signals from the microphones 1 and 2 may be supplied to the input terminal of the wind noise reducing apparatus according to the embodiments above, or a sound pickup system (method) for electronic equipment such as a video camera or a recording/playing system (method) may be configured therewith. However, the invention is not limited thereto but may be implemented in a recording/playing apparatus or a sound pickup apparatus for electronic equipment. The invention may be implemented as application software in a computer and may be apparently implemented as non-realtime processing to be performed in editing a video/audio file, file conversion or writing on a DVD disk.

It should be understood by those skilled in the art that various modifications, combinations, sub-combinations and alterations may occur depending on design requirements and other factors insofar as they are within the scope of the appended claims or the equivalents thereof.

What is claimed is:

1. A noise reducing apparatus comprising:
input means for inputting multiple audio signals from multiple audio channels;
multiple band extracting means for extracting a predetermined band from the multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, for each of the predetermined period of times, the signal having the lowest level value of the level values detected by the multiple first level detecting means and the second level detecting means;
band limiting means for limiting the band of the signal from the selecting means; and
band synthesizing means for band-synthesizing the signal from the band limiting means and the signal in a band, which is not extracted by the multiple band extracting means, for each audio channel,
wherein the output of the band synthesizing means is an audio channel output signal.

2. A noise reducing apparatus comprising:
input means for inputting multiple audio signals from multiple audio channels;
multiple band extracting means for extracting a predetermined band from the multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, in each audio channel and for each of the predetermined period of times, the signal having a lower level value between the level values from the multiple first level detecting means and the level value from the second level detecting means;
multiple band limiting means for limiting the bands of the signals from the selecting means; and
band synthesizing means for band-synthesizing the signals from the multiple band limiting means and the signal in the band, which is not extracted by the multiple band extracting means, for each audio channel,
wherein the output of the band synthesizing means is an audio channel output signal.

3. The noise reducing apparatus according to claim 1 or 2, wherein the band extracting means includes multiple filter means.

4. The noise reducing apparatus according to claim 1 or 2, wherein the band extracting means includes fast Fourier transform means (FFT).

5. The noise reducing apparatus according to claim 1 or 2, wherein the minimum unit of the predetermined period of time is a period for sampling a noise band.

6. The noise reducing apparatus according to claim 1 or 2, further comprising:
control means for adjusting the mix ratio between the multiple input audio signals and each audio channel output signal.

7. The noise reducing apparatus according to claim 6, wherein the control means adjusts the mix ratio based on a noise level.

8. A noise reducing method comprising the steps of:
inputting multiple audio signals from multiple audio channels;
extracting a predetermined band from the multiple audio signals;
averaging signals from the multiple band extracting steps;
detecting a first signal level in a predetermined period of time of the signals from the multiple band extracting steps;
detecting a second signal level in a predetermined period of time from the averaging step;
selecting, for each of the predetermined period of times, the signal having the lowest level value of the level values detected by the first signal level detecting step and the second signal level detecting step;
limiting the band of the signal from the selecting step; and
band-synthesizing the signal from the band limiting step and the signal in a band, which is not extracted by the multiple band extracting steps, for each audio channel,
wherein the output of the band synthesizing step is an audio channel output signal.

9. A noise reducing method comprising:
inputting multiple audio signals from multiple audio channels;
extracting a predetermined band from the multiple audio signals;
averaging signals from the multiple band extracting steps;
detecting a first signal level in a predetermined period of time of the signals from the multiple band extracting steps;
detecting a second signal level in a predetermined period of time of the signal from the averaging step;
selecting, in each audio channel and for each of the predetermined period of times, the signal having a lower level value between the level values from the first signal level detecting step and the level value from the second signal level detecting step;
limiting the bands of the signals from the selecting step; and
band-synthesizing the signals from the multiple band limiting steps and the signal in the band, which is not extracted by the multiple band extracting steps, for each audio channel,
wherein the output of each of the band synthesizing steps is an audio channel output signal.

10. A noise reducing program comprising:
input means for inputting multiple audio signals from multiple audio channels;
multiple band extracting means for extracting a predetermined band from the multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, for each of the predetermined period of times, the signal having the lowest level value of the level values detected by the multiple first level detecting means and the second level detecting means;
band limiting means for limiting the band of the signal from the selecting means; and
band synthesizing means for band-synthesizing the signal from the band limiting means and the signal in a band, which is not extracted by the multiple band extracting means, for each audio channel,
wherein the output of the band synthesizing means is an audio channel output signal.

11. A noise reducing program comprising:
input means for inputting multiple audio signals from multiple audio channels;
multiple band extracting means for extracting a predetermined band from the multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, in each audio channel and for each of the predetermined period of times, the signal having a lower level value between the level values from the multiple first level detecting means and the level value from the second level detecting means;
multiple band limiting means for limiting the band of the signals from the selecting means; and
band synthesizing means for band-synthesizing the signal from the multiple band limiting means and the signal in the band, which is not extracted by the multiple band extracting means, for each audio channel,
wherein the output of the band synthesizing means is an audio channel output signal.

12. A sound pickup apparatus for electronic equipment that picks up multiple audio signals from multiple audio channels, the apparatus comprising:
multiple band extracting means for extracting a predetermined band from multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, for each of the predetermined period of times, the signal having the lowest level value of the level values detected by the multiple first level detecting means and the second level detecting means;
band limiting means for limiting the band of the signal from the selecting means; and
band synthesizing means for band-synthesizing the signal from the band limiting means and the signal in a band, which is not extracted by the multiple band extracting means, for each audio channel,
wherein the output of the band synthesizing means is an audio channel output signal.

13. A sound pickup apparatus for electronic equipment that picks up multiple audio signals from multiple audio channels, the apparatus comprising:
multiple band extracting means for extracting a predetermined band from the multiple audio signals;
calculating means for averaging signals from the multiple band extracting means;
multiple first level detecting means for detecting the signal levels in a predetermined period of time of the signals from the multiple band extracting means;
second level detecting means for detecting the signal level in a predetermined period of time of the signal from the calculating means;
selecting means for selecting, in each audio channel and for each of the predetermined period of times, the signal having a lower level value between the level values from the multiple first level detecting means and the level value from the second level detecting means;
multiple band limiting means for limiting the bands of the signals from the selecting means; and
band synthesizing means for band-synthesizing the signals from the multiple band limiting means and the signal in the band, which is not extracted by the multiple band extracting means, for each audio channel,
wherein the output of the band synthesizing means is an audio channel output signal.

14. A noise reducing apparatus comprising:
an input section inputting multiple audio signals from multiple audio channels;
multiple band extracting sections extracting a predetermined band from the multiple audio signals;
a calculating section averaging signals from the multiple band extracting sections;
multiple first level detecting sections detecting the signal levels in a predetermined period of time of the signals from the multiple band extracting sections;
a second level detecting section detecting the signal levels in a predetermined period of time of the signal from the calculating section;
a selecting section selecting, for each of the predetermined period of times, the signal having the lowest level value of the level values detected by the multiple first level detecting sections and the second level detecting section;
a band limiting section limiting the band of the signal from the selecting section; and
a band synthesizing section band-synthesizing the signal from the band limiting section and the signal in a band, which is not extracted by the multiple band extracting sections, for each audio channel,
wherein the output of the band synthesizing section is an audio channel output signal.

15. A noise reducing apparatus comprising:
an input section inputting multiple audio signals from multiple audio channels;
multiple band extracting sections extracting a predetermined band from the multiple audio signals;
a calculating section averaging signals from the multiple band extracting sections;
multiple first level detecting sections detecting the signal levels in a predetermined period of time of the signals from the multiple band extracting sections;
a second level detecting section detecting the signal level in a predetermined period of time of the signal from the calculating section;
a selecting section selecting, in each audio channel and for each of the predetermined period of times, the signal having a lower level value between the level values from the multiple first level detecting sections and the level value from the second level detecting section;
multiple band limiting sections limiting the bands of the signals from the selecting section; and
a band synthesizing section band-synthesizing the signals from the multiple band limiting sections and the signal in the band, which is not extracted by the multiple band extracting sections, for each audio channel,
wherein the output of the band synthesizing section is an audio channel output signal.
